(19) United States
(12) Patent Application Publication
(10) Pub. No.: US 2018/0286028 A1
(43) Pub. Date: Oct. 4, 2018

(54) CLOUD BASED AUTHENTICATION SYSTEM

(71) Applicants: My T. NGUYEN, Tra Vinh City, Travinh Province, OT (VN); Anh T. DUONG, Duong Dong Town, OT (VN); Cuong Q. HONG, Tra Vinh City, Travinh Province, OT (VN); An TRINH, Tra Vinh City, Tra Vinh Province, OT (VN); Thong A. NGUYEN, Tra Vinh City, Tra Vinh Province, OT (VN); Khang M. DUONG, Can Tho City, OT (VN); Rynan Technologies Pte. Ltd., Singapore, OT (SG)

(72) Inventors: MY T. NGUYEN, TRA VINH CITY (VN); ANH T. DUONG, DUONG DONG TOWN (VN); CUONG Q. HONG, TRA VINH CITY (VN); AN TRINH, TRA VINH CITY (VN); THONG A. NGUYEN, TRA VINH CITY (VN); KHANG M. DUONG, Can Tho City (VN)

(21) Appl. No.: 15/764,775

(22) PCT Filed: Oct. 3, 2016
(86) PCT No.: PCT/CA2016/051146

§ 371 Date: Mar. 29, 2018

Related U.S. Application Data
(60) Provisional application No. 62/235,742, filed on Oct. 1, 2015.

(51) Int. Cl. G06T 7/00; G06K 9/00; G06Q 30/00; G06K 7/14; G06K 7/10; G06Q 20/20

(52) U.S. Cl. CPC G06T 7/001; G06K 9/00442; G06Q 20/208; G06K 7/1417; G06K 7/10722; G06Q 30/0185

(57) ABSTRACT

A cloud based authentication method for determining the authenticity of a plurality of a typically counterfeited product each held in a sealed product packaging and for sale to a consumer. A unique identifier is created for each package, attached to the package and stored in the cloud. The identifier is subsequently acquired at different stages, compared with the identifier stored in the cloud and a change in status of the product associated with the identifier made.

### FIELD OF THE INVENTION

The present invention relates to a cloud based authentication system.

### BACKGROUND TO THE INVENTION

Cloud based anti-counterfeiting provides an effective means to prevent counterfeiting of goods. US Patent Application No. 20140095398 discloses a method and system for the authentication of genuine goods to prevent counterfeits. The system for anti-counterfeiting includes a client apparatus, an authentication server, a product identity mark, a merchant identity mark, and a communication channel between client and server. Both product identity mark and merchant identity mark are embedded with their corresponding unique identity codes. These codes are entered and stored in a database of the authentication server before goods entering into commerce. The client apparatus includes software to scan the merchant identity mark and product identity mark to acquire both identity codes which are then sent to an authentication server. The server compares product and merchant identity code pairs with information of previous code pairs stored in a database. The comparison result together with additional information detailing the merchant is sent to the client apparatus as either an indication of the authenticity of the goods or an indication they are counterfeit.

U.S. Pat. No. 8,297,510 disclosed the mathematical method of 2D barcode authentication and encryption, utilizing a digital signature concept for embedded processing, which employs an error correction mechanism built into the 2D barcodes to protect them from counterfeiting. Similarly, U.S. Pat. No. 8,249,350 disclosed a method and apparatus for protection of products and packaging against counterfeiting using dedicated authentication protocol coupled with portable devices.

However, one disadvantage of the above prior art methods is that communication with the authentication server is required.

### SUMMARY OF THE INVENTION

In particular, there is provided a cloud based authentication method for determining the authenticity of a plurality of a typically counterfeited product each held in a sealed product packaging and for sale to a consumer. The method comprises, during a packing stage, encoding a unique product identifier into a unique encrypted 2D data matrix identifier for each of the plurality of product, graphically manipulating each of the matrix identifier to form an unique product identifier image (UPII), printing each of the UPII on the sealed packaging containing the product associated with the UPII, capturing an image of each of the UPII immediately following the printing, and storing the unique product identifier encoded in the graphically manipulated captured image in a cloud based date store together with a status indicating the product associated with the unique product identifier is available for sale, during a sales stage by the product seller capturing an image of a UPII of a product to be sold to the consumer using a point of sale device (POSD), authenticating the product to be sold by matching the unique product identifier in the captured UPII with a matching one of the unique product identifiers stored in the cloud based date store, changing a status of a matching one of the stored UPII images from available for sale to sold, and selling the authenticated product to the consumer, during the sales stage by the consumer capturing an image of the UPII of a product to be bought using a handheld device comprising a verification application, verifying the captured UPII offline by reversing the graphical manipulation and recognizing the encrypted 2D data matrix identifier, authenticating the product to be bought by matching the unique product identifier in the captured UPII with a matching one of the unique product identifiers in the cloud based date store and verifying that a status of the matching one is available for sale, and purchasing the authenticated product.

### BRIEF DESCRIPTION OF THE DRAWINGS

FIG. 1 provides a schematic diagram of a system for cloud based authentication in accordance with an illustrative embodiment of the present invention;

FIG. 2 provides an additional schematic diagram of a system for cloud based authentication in accordance with an illustrative embodiment of the present invention;

FIG. 3 provides a flow chart of a method for cloud based authentication in accordance with an illustrative embodiment of the present invention; and

FIGS. 4 and 5 provide examples of bar code manipulation in accordance with illustrative embodiments of the present invention.

### DETAILED DESCRIPTION OF THE ILLUSTRATIVE EMBODIMENTS

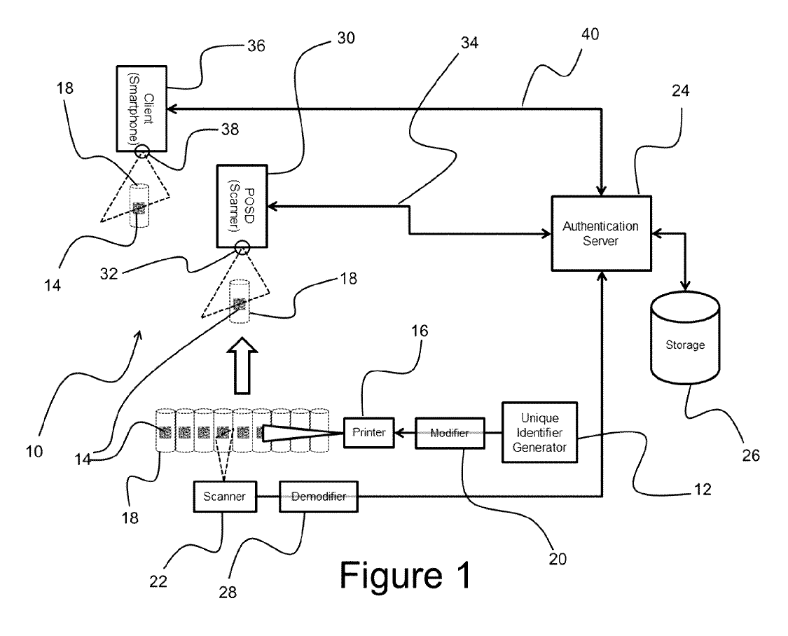

Referring now to FIG. 1, a cloud based authentication system in accordance with an illustrative embodiment of the present invention, and generally referred to using the reference numeral 10, will now be described. The system 10 comprises a unique identifier generator 12 which generates for example a Unique Product Identifier Image (UPII) 14 such as 2D matrix barcode or the like for printing using a printer 16 on the primary packaging 18 of items typically susceptible to counterfeiting. Prior to printing on the packaging 18, and as will be discussed in more detail below, the 2D images 14 are graphically manipulated, scrambled or otherwise altered by a modifier 20. Following printing, the graphically manipulated images are captured by an inspection system comprising an imaging device such as a scanner 22 and transferred to an authentication server 24 for storage in a cloud based data store 26. Illustratively, the images captured by the scanner 22 are returned to their original unaltered format via a demodifier 28 which undoes the graphical manipulation prior to transferring to the authentication server 24 for storage.

Still referring to FIG. 1, the system 10 also comprises a plurality of point of sale devices (POSD) 30 each comprising an imaging device 32 such as a scanner which is capable of capturing the 2D images 14 printed on the packaging 18. The POSD 30 also includes appropriate software and/or applications (not shown) for decrypting the captured UPII images as well as a wired or wireless communication link 34, for example comprising an appropriate communications stack and the internet (both not shown), for communicating with the authentication server 24 and its associated storage 26. The software and/or applications include the ability to modify the status of entries within the authentication server 24 and its associated storage 26 from being available for sale to being sold.

Additionally, the system 10 comprises a plurality of Retailer/Consumer Authentication Devices (RCADs) 36, such as a desktop computer, smartphone or tablet or the like, each equipped with a software application (client) and an imaging device 38 such as a scanner which is capable of capturing a UPII 14 printed on the packaging 18 and decoding the UPII. Each RCAD 36 is able to communicate with the authentication server 24 via wired or wireless network 40. The software and mobile app of the RCAD comprises a decoded key and decrypted key, which provides the ability to recognize the authenticity of UPIIs without communicating with the authentication server.

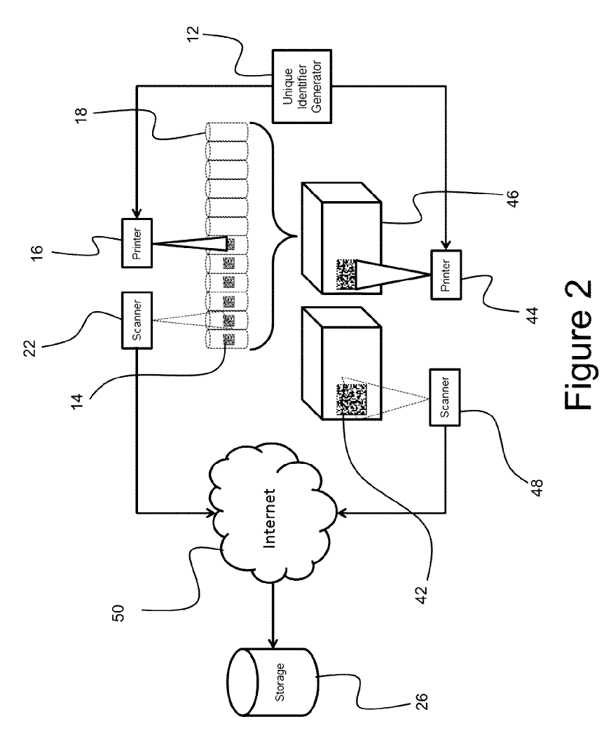

Referring now to FIG. 2, in addition to printing a unique one use image such as a unique 2D barcode 14 on individual product packages 18, the unique identifier generator 12 may also be used to generate unique one use identifiers 42 for printing using a box printer 44, for example, on secondary packaging 46 such as boxes containing a plurality of primary packages 18 of typically counterfeited product. Similarly, once printed the identifier such as a 2D barcode 40 is captured by a scanner 48 for transfer via the Internet 50, for example, to the authentication server (reference 24 in FIG. 1) and storage in the cloud based data store 26.

More specifically, the process for the cloud based authentication of this invention comprises the following steps:
a. Generating and encrypting the 2D barcodes, preferably in quick response and 2D data matrix formats by using an off-line software or Software as a Service (SaaS). The encryption is based on the Advanced Encryption Standards (AES) given in NIST FIPS PUB 197 using a secret key. The encrypted 2D barcodes are then converted to graphic images.
b. Graphically manipulating the obtained graphic images according to one or more undisclosed effects, such as image flipping, rotating, color marking, module deleting, module adding, module moving, merging with different images, super imposing on different image and others, which increases the degree of difficulty for counterfeiting. The manipulated graphic image is then assigned as a UPII. Each product 18 has only one UPII.
c. The UPIIs may be stored conveniently in a memory of a printer server for later printing.
d. Printing the UPIIs on the primary or secondary packages of the product items using a digital printer 16 or laser marker.
e. Confirming the printed UPIIs on the product packages by using the inspection system 22 comprising a camera and software. The inspected UPII is entered and stored in the database 26 of the authentication server 24 before products entering into the commercial distribution network.
f. Upon selling a product item, the POSD 30 captures the UPII of the item being purchased and communicates with the authentication server 24 to confirm the authenticity of the item. If the item is genuine, the POSD 30 changes the status of the purchasing UPII from “available for sale” to “sold” in the database 26 of the authentication server 24.
g. Before purchasing a product item, a consumer or retailer may use the ROAD 36 to capture the UPII of the item being purchased. Failure by the ROAD 36 to correctly recognize the UPII indicates the product item is likely counterfeit. Of note is that the recognition action can be done off-line. On the other hand, recognition of a UPII by the RCAD 36 confirms product is likely genuine. The RCAD 36 then communicates with the authentication server 24 to compare the UPII with the contents of the database 26. If the UPII matches a UPII with status “sold”, the product is likely counterfeit. Otherwise, the product item is indicated as being genuine and the sale can proceed.

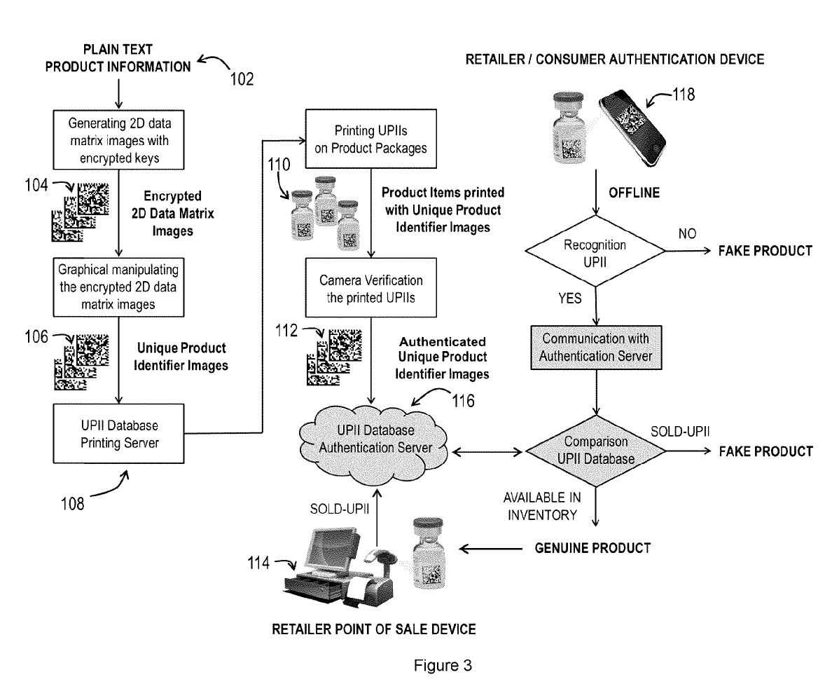

Referring now to FIG. 3, a flow chart of a process for cloud based authentication will now be described, which includes the production information in the plain text format 102. A standalone software or Software as a Service generates, encrypts and converts the product information in plain text to the 2D barcode graphic image 104. A standalone software of Software as a Service manipulates graphically the 2D barcode graphic image with secret rules to form the UPII 106 which is for example stored in the database of printing server 108. A digital printer or laser marker print the UPII onto the package of the product item 110. An inspection system comprising a camera and software captures the printed UPII on the package of the product item, then uploads the UPII to the authentication server 110 as Authenticated UPIIs 112 before the products are distributed through different commercial channels. A cloud based point of sale device 114 captures the UPII to complete the sale transaction, then updates the status of the UPII to sold in the authentication server 116. Before purchasing a product item, a consumer or retailer may use the retailer/consumer authentication device (RCAD) 118 to capture the UPII of the intended purchasing product item. Failure to recognize the UPII indicates the product is counterfeit. This action can be done off-line. On the other hand, recognition of a UPII by the ROAD confirms the product as being likely genuine. Then, ROAD communicates with the authentication server to compare with the database. If the UPII is matched with a UPII having status “sold”, the product is likely counterfeit. Otherwise, the product item is considered genuine.

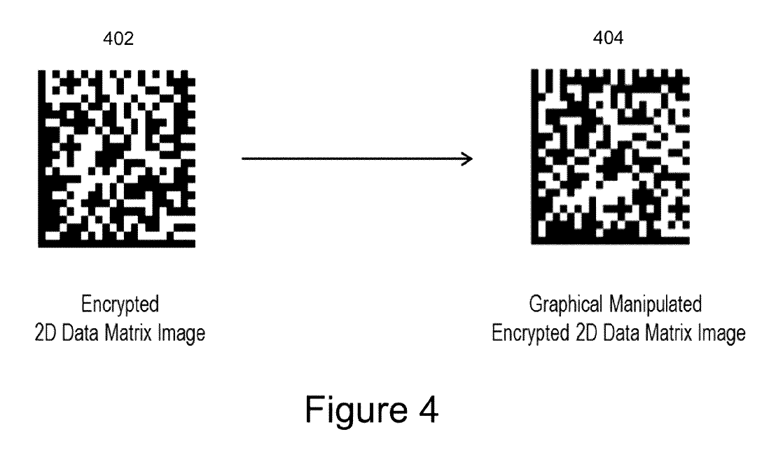

Referring now to FIG. 4, an example of the graphical manipulating by reorientation the encrypted 2D data matrix image 402 to form a unrecognizable encrypted 2D data matrix 404.

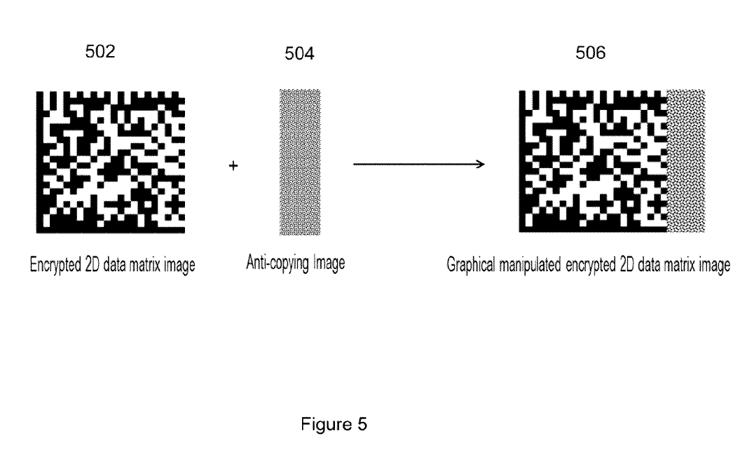

Referring now to FIG. 5, an example of the graphically manipulating the encrypted 2D data matrix image 502 is described in the following by merging the encrypted 2D data matrix image with an anti-copying image 504 to form a graphical manipulated encrypted 2D data matrix image 506, which can prevent the image to be copied.

Although the present invention has been described hereinabove by way of specific embodiments thereof, it can be modified, without departing from the spirit and nature of the subject invention as defined in the appended claims.

We claim:

1. A cloud based authentication method for determining the authenticity of a plurality of a typically counterfeited product each held in a sealed product packaging and for sale to a consumer, the method comprising:
during a packing stage:
encoding a unique product identifier into a unique encrypted 2D data matrix identifier for each of the plurality of product;
graphically manipulating each of said matrix identifier to form an unique product identifier image (UPII);
printing each of said UPII on the sealed packaging containing the product associated with said UPII;
capturing an image of each of said UPII immediately following said printing; and
storing said unique product identifier encoded in said graphically manipulated captured image in a cloud based date store together with a status indicating the product associated with said unique product identifier is available for sale;
during a sales stage to the product seller:
capturing an image of a UPII of a product to be sold to the consumer using a point of sale device (POSD);
authenticating said product to be sold by matching said unique product identifier in said captured UPII with a matching one of said unique product identifiers stored in said cloud based date store;
changing a status of a matching one of said stored UPII images from available for sale to sold; and
selling said authenticated product to the consumer;
during the sales stage to the consumer:
capturing an image of said UPII of a product to be bought using a handheld device comprising a verification application;
verifying said captured UPII offline by reversing said graphical manipulation and recognizing said encrypted 2D data matrix identifier;
authenticating said product to be bought by matching said unique product identifier in said captured UPII with a matching one of said unique product identifiers in said cloud based date store and verifying that a status of said matching one is available for sale; and
purchasing said authenticated product.
